(19) United States
(12) Patent Application Publication
(10) Pub. No.: US 2013/0078599 A1
(43) Pub. Date: Mar. 28, 2013

(54) DECK OF GREEK ALPHABET WITH CORRESPONDING ENGLISH LETTERS AND CELESTIAL CARDS FOR PLAYING EDUCATIONAL WORD GAME

(71) Applicant: Joseph D. Bongiorno, Nahant, MA (US)

(72) Inventor: Joseph D. Bongiorno, Nahant, MA (US)

(73) Assignee: Joseph Bongiorno, Nahant, MA (US)

(21) Appl. No.: 13/246,591

(22) Filed: Sep. 27, 2011

(51) Int. Cl. G09B 19/22

(52) U.S. Cl. 434/129

(57) ABSTRACT

An entertaining and educational word-forming card game for increasing memory and mental agility, along with learning the Greek alphabet, spelling, vocabulary, grammar, arithmetic, astronomy and mythology, utilizing a deck of fifty-two cards. The fifty-two card deck is a combination of twenty-four alphabet cards and twenty-eight celestial object cards. The alphabet cards display the twenty-four Greek letter names, uppercase Greek letter, and lowercase Greek letter, along with English equivalents. The alphabet cards are dealt out to the players and used to form words, while the celestial object cards are placed in a draw pile to be acquired by the players for each word formed. Each celestial object card has a point value associated with it for determining the score. The player who acquires the bonus card has a final opportunity to score additional points by creating a grammatically correct sentence out of all the words formed during play.

### BACKGROUND OF THE INVENTION

1. Field of Invention

The present invention pertains to card games. Specifically the present invention pertains to a card game for word and sentence forming employing the Greek alphabet, both upper and lower case along with their Greek name, their English equivalent and English variant(s). Celestial object cards assist in determining the outcome of play.

2. Description of Prior Art

There are numerous types of games involving cards, tiles or blocks for use in play.

Certain card games teach the player the alphabet. Such card games are described in the following patents: U.S. Pat. No. 5,772,212; Hagedorn: Jun. 30, 1998; U.S. Pat. No. 6,276,940; White: Aug. 21, 2001; U.S. Pat. No. 6,402,144; Ekberg: Jun. 11, 2002

Certain card games promote spelling. Such card games are described in the following patents: U.S. Pat. No. 5,409,237; Marcley et al.: Apr. 25, 1995; U.S. Pat. No. 5,417,432; Dwyer: May 23, 1995; U.S. Pat. No. 5,863,043; Bitner: Jan. 26, 1999; U.S. Pat. No. 5,906,492; Putterman: May 25, 1999; U.S. Pat. No. 6,966,556; Culley et al.: Nov. 22, 2005;

Certain card games increase the player's vocabulary or grammar. Such card games are described in the following patents: U.S. Pat. No. 4,192,513; Feeley et al.: May 11, 1980; U.S. Pat. No. 4,333,656; Sommer: Jun. 8, 1982; U.S. Pat. No. 6,623,009; Kraemer et al.: Sep. 23, 2003; U.S. Pat. No. 6,655,688; Boateng: Dec. 2 , 2003; U.S. Pat. No. 7,344,137; Loke: Mar. 18, 2008; U.S. Pat. No. 7,568,703; Fernandes: Aug. 4, 2009;

Some card games utilize arithmetic for the purpose of scoring and determining a winner of a game. Such card games are described in the following patents: U.S. Pat. No. 4,428,582; Smith: Jan. 31, 1984; U.S. Pat. No. 4,976,058; Breen: Nov. 27, 1990; U.S. Pat. No. 5,310,347; Brand: May 10, 1994; U.S. Pat. No. 7,845,643; Gram, Jr.: Dec. 7, 2010;

Other games benefit the player's memory and mental agility. Such games are described in the following patents: U.S. Pat. No. 4,138,119; Brannon: Feb. 6, 1979; U.S. Pat. No. 4,402,513; Head: Sep. 6, 1983; U.S. Pat. No. 7,021,629; McCabe: Apr. 4, 2006;

Some games familiarize the players with mythology, the zodiac, solar system or other celestial objects. Such games are described in the following patents: U.S. Pat. No. 1,139,356; Fields: May 11, 1915; U.S. Pat. No. 4,236,720; Belony: Dec. 2, 1980; U.S. Pat. No. 6,267,377; Griggs: Jul. 31, 2001; G.B. Pat. No. 517,941; Taylor: Feb. 13, 1940; G.B. Pat. No. 941,380; Manela: Nov. 13, 1963;

Some card games have a fortune-telling entertainment component to them. Such a card game is described in the following patent: U.S. Pat. No. 4,014,551; Alfonso: Mar. 29, 1977

### PRINCIPAL OBJECTS OF THE INVENTION

These patents describe many different types of educational and entertainment type card games. Some card games teach the alphabet, while others focus on spelling, word forming, vocabulary and grammar. Some card games employ arithmetic for scoring. Some games benefit a player's memory and mental agility. Some games employ ancient mythology, the zodiac, solar system or other celestial objects for both entertainment and educational purposes. Some card games have a fortune-telling component to them. The greatest advantage of the present invention is that it employs all of these educational and entertainment characteristics along with exposure to the Greek alphabet into a simple card game with a minimal number of cards, commercially referred to as COSMIC CONNEXION™. The objective of this educational card game is to familiarize the player with the Greek alphabet. The Greek alphabet is widely utilized in many fields of math and science, yet not widely recognized to the general public. By becoming familiar with the Greek alphabet, a student will be less intimidated when they encounter their use in other studies. Along with increasing literacy, the goal of the present invention is to encourage interest in math, science, engineering and technology in a fun and useful manner.

### SUMMARY OF THE INVENTION

This invention consists of a plurality of cards, but could be accomplished using tiles, blocks, or an electronic recreation of these cards, such as computer software, home/commercial gaming system or smart phone application. The deck of cards consists of 52 individual cards, each having a common back. There are two types of cards; alphabet cards and celestial cards.

There are 24 alphabet cards which represent the 24 letters of the Greek alphabet. Each alphabet card displays the name of one of the Greek letters, the upper and lower case character associated with that Greek letter along with their English equivalent and a possibility of 1 or 2 English equivalent variants. The deck of cards of the present invention displays the Greek to English alphabet translation, but could also display Greek to Latin alphabet translation, Greek to Russian alphabet translation, Greek to Arabic alphabet translation, Greek to Hebrew alphabet translation, Greek to Hindi alphabet translation or Greek to Chinese alphabet translation. The deck of cards of the present invention is for the English language, but could be modified for Latin, Portuguese, Spanish, French, Italian or German as well as Russian, Arabic, Hebrew, Hindi, Japanese or Chinese.

For additional educational purposes these cards could also include the most common known definitions for mathematical symbols or variables for these Greek letters for example; Σ for summation, λ for wavelength, or definition of constants like π=3.14159, or Φ=1.61803.

There are 28 celestial object cards which represent the 12 most familiar objects within our local solar system, the 12 constellations of the zodiac and 4 wild cards. All 28 celestial cards have a number associated with them, which is used for scoring points. Each solar system object card displays an image of the object, both the Greek and Roman name associated with that particular solar system object along with any mythological associations. Each zodiac constellation card displays the common symbol associated with a particular zodiac constellation, the zodiac constellation's name and English equivalent, and may also include the dates associated with the particular zodiac constellation. The 4 wild cards consist of individual images of a black hole, a supernova, a comet and a meteor.

### BRIEF DESCRIPTION OF DRAWINGS

FIG. 1 shows the individual faces of the 24 alphabet cards, the name of each letter of the Greek alphabet is presented with both the upper and lower case character associated with that Greek letter along with it's English equivalent and a possibility of 1 or 2 English equivalent variants.

FIG. 2 shows the individual faces of the 12 solar system object cards, each solar system object card has a number associated with it and displays an image of the object, both the Greek and Roman name associated with that particular solar system object along with any mythological associations.

FIG. 3 shows the individual faces of the 12 zodiac constellation cards, each zodiac constellation card has a number associated with it and displays the common symbol associated with each particular zodiac constellation, the zodiac constellation's name and English equivalent.

FIG. 4 shows the individual faces of the 4 wild cards which consist of individual images of a black hole, a supernova, a comet and a meteor, each of these cards have a number associated with them.

FIG. 5 is a table listing the 24 letters of the Greek alphabet, the columns show; the Greek letter name, Greek uppercase letter, Greek lowercase letter, English equivalent and additional variants if applicable.

FIG. 6 is a table of the 28 celestial objects with the point values associated with each celestial object.

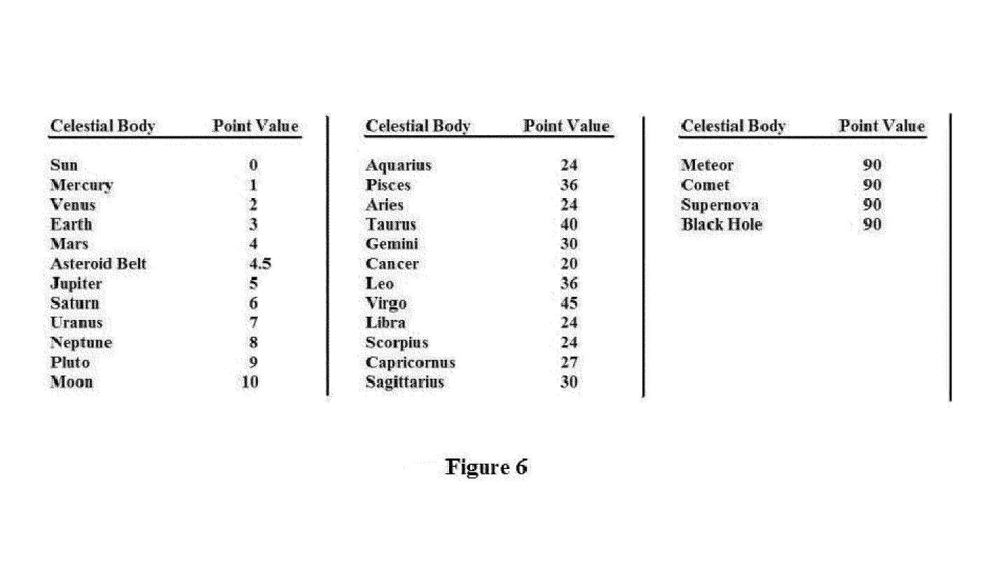

FIG. 7 shows a configuration of a particular method of play.

### DETAILED DESCRIPTION OF PREFERRED EMBODIMENT

The deck of playing cards in the present invention will provide the users thereof a large variety of new and simple games. One example will be described herein. However, it is to be understood the described game does not limit the present invention as it is merely illustrative of the present invention's versatility.

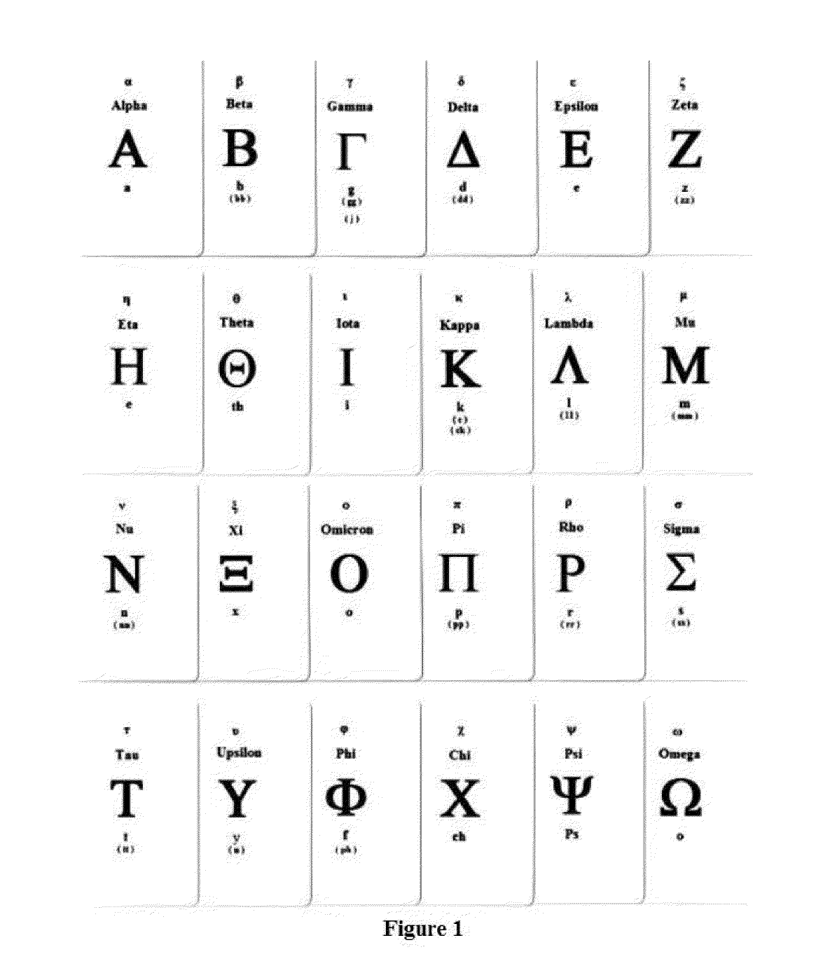

Referring now to FIG. 1, separate the 24 Greek letter cards from the rest of the deck, shuffle these cards and place them aside.

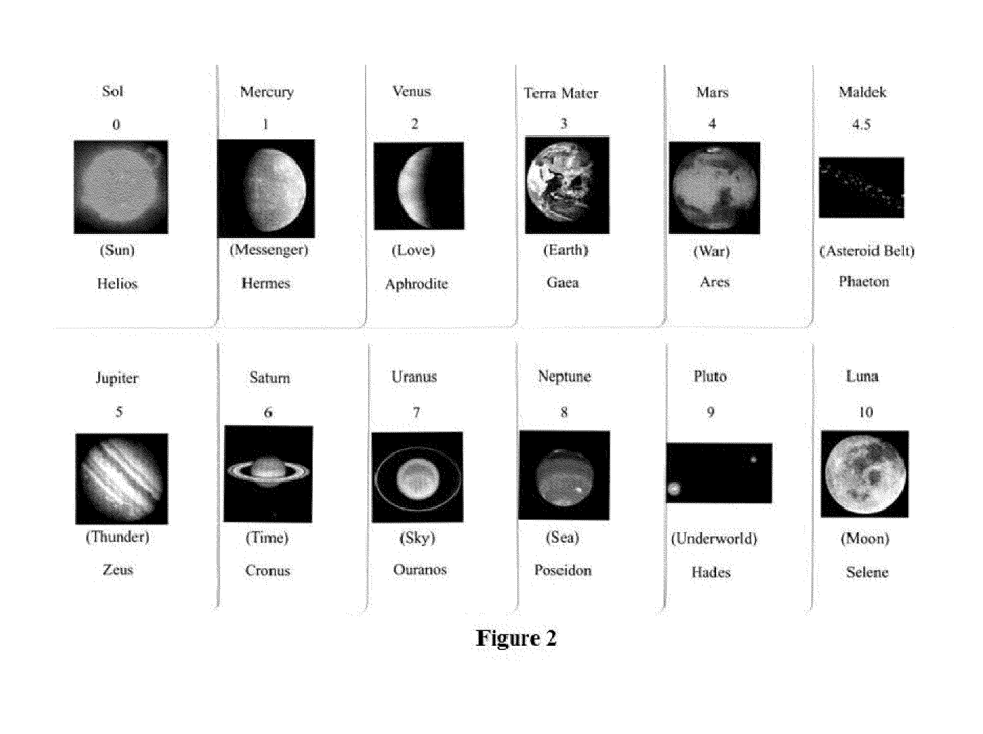

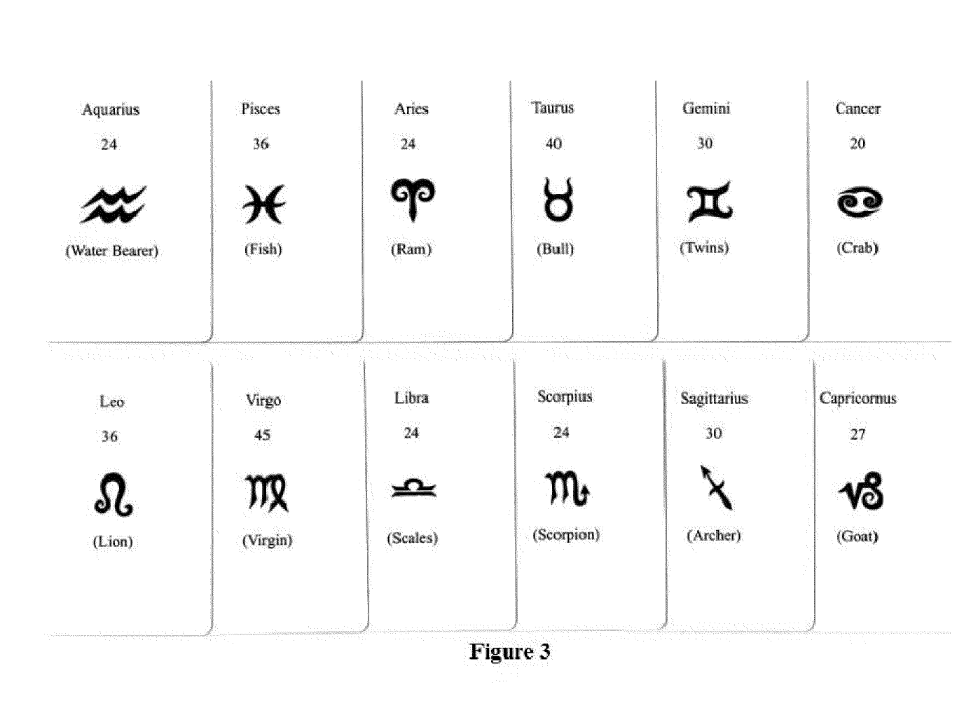

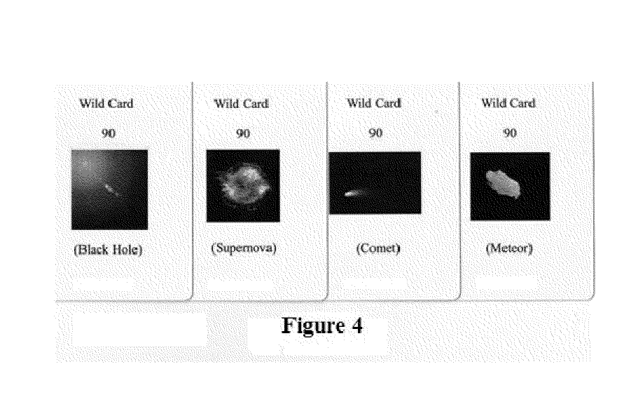

Referring now to FIG. 2, FIG. 3 and FIG. 4, gather the remaining 28 celestial/point value cards, these cards will become the draw pile. Give the draw pile to the player assigned to be the scribe for shuffling. The scribe is the player who will keep track of the words created by each player on a piece of paper or board and award one card from the draw pile for each word created.

Deal out the Greek letter cards face down in the normal clockwise direction until all 24 cards have been dealt out. The number of players will dictate how many cards each player has at the start of a game.

For 2 players each player will receive 12 cards;

For 3 players each player will receive 8 cards;

For 4 players each player will receive 6 cards;

For 5 players, four players will receive 5 cards, and one player receive have 4 cards;

For 6 players each player will receive 4 cards;

For 7 players, three players will receive 4 cards, and four players will receive 3 cards;

For 8 players each player will receive 3 cards.

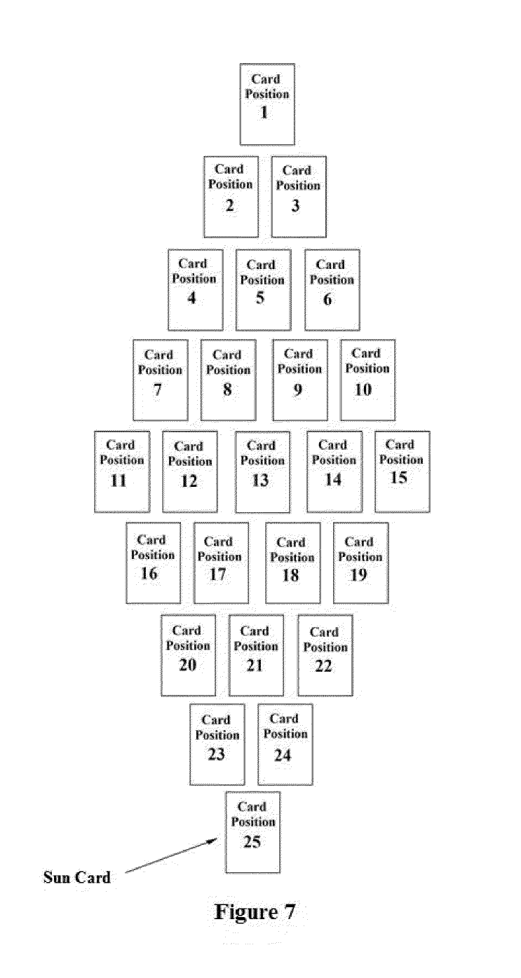

The player to the left of the dealer will be the first player to place a Greek letter card of their choice in position 1 of the configuration shown in FIG. 7. In a clockwise direction the next player will place a Greek letter card of their choice in position 2 of the configuration shown in FIG. 7.

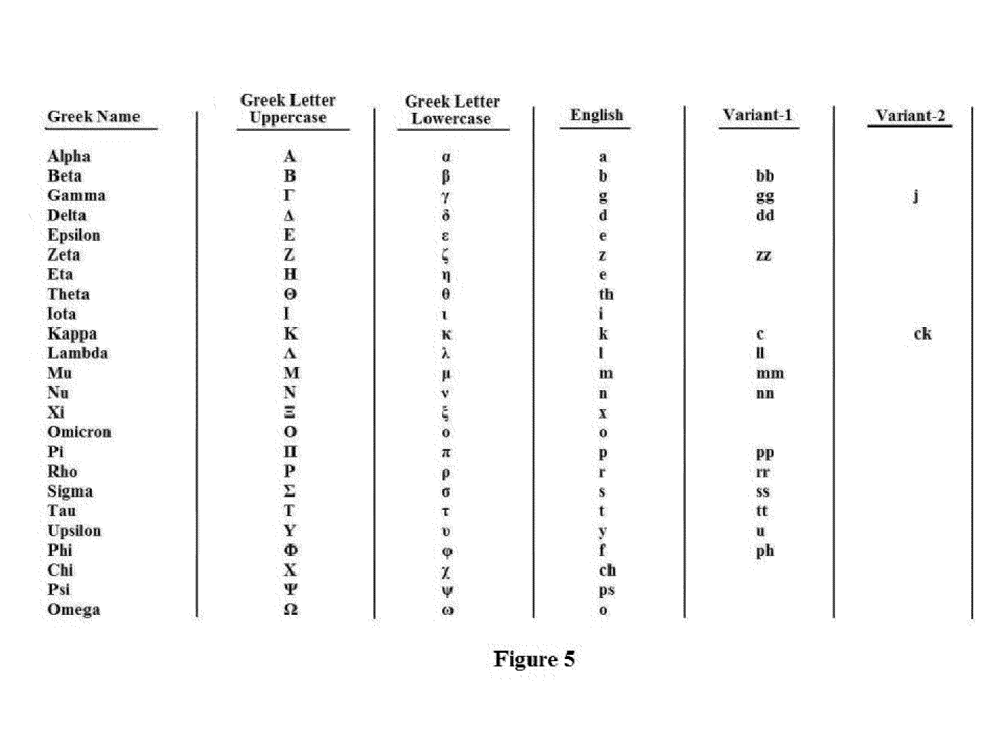

This method is repeated for each player's turn. Each player has a fixed amount of time during their turn to discover a word or words which is displayed within this configuration. Words are formed using any one of the representations on a card; Greek name, Greek Uppercase letter, Greek lowercase letter, English equivalent, Variant 1 or Variant 2 if applicable as shown in FIG. 5 which connects with another card or cards (Greek name, Greek Uppercase letter, Greek lowercase letter, English equivalent, Variant 1 or Variant 2) in a diagonal or horizontal fashion to form a word. Each time a word is formed the scribe writes down the word and rewards the player one celestial/point value card for each word formed. Players collect celestial/point value cards and keep them separate from their Greek letter cards. All of the celestial/point value cards have a value between 1 to 90 points, except for the sun card which has a 0 value on it. The sun card is the single most sought after card. The sun card is the bonus card. If more than 28 words have been created before all 24 Greek letter cards have been played, causing the scribe to run out of celestial/point value cards then a player can pilfer a celestial/point value card from another player of their choosing. The word must be at least 4 letters for a player to pilfer a card from another player. The scribe must continue to write down the words formed until all 24 Greek letter cards have been played. After the 24^{th} Greek letter card has been played, the word forming potion of the game is complete. The player's scores are determined by summing up the values of the celestial/point value cards they have acquired during play. However, to complete the game the player who has acquired the sun card has an opportunity to score additional points. The holder of the sun card enters the bonus round by revealing the sun card and placing it in the 25^{th} card position as shown in FIG. 7. This player has a fixed amount of time to examine the words created during play and written down by the scribe to create a grammatically correct sentence. The player can use as many or as few words from the list as they choose to create a sentence. If the player is successful in creating a grammatically correct sentence, they receive an additional 25 points per word from the sentence created to add to their total. However, if the sentence they create can be considered prophetic or fortune-telling in nature, they receive 50 points per word from the sentence created to add to their total. The player with the highest score wins.

I claim:

1. A deck of playing cards for playing a word-forming game, the deck comprising fifty-two cards:
a) Twenty-four alphabet cards.
(1) The front face of each of the cards containing indicia representative of a single letter of the Greek alphabet
b) Twenty-eight celestial object cards
(1) Twelve solar system object cards, the front face of each of the cards containing indicia representative of familiar objects of the local solar system
(2) Twelve zodiac constellation cards, the front face of each of the cards containing indicia representative of the constellations of the zodiac
(3) Four wild cards

2. A deck of playing cards as in claim 1, wherein a rear face of each of the cards contains a like graphic design.

3. A deck of playing cards as in claim 1, wherein the face of each of the alphabet cards comprise:
a) A Greek letter name
b) Greek uppercase letter
c) Greek lower case letter
d) Greek to English equivalent
e) Additional English variant(s)

4. A deck of playing cards as in claim 1, wherein the face of each of the solar system cards comprise:
a) A unique numerical value
b) Object's Greek name
c) Object's Roman name
d) Mythological meaning

5. A deck of playing cards as in claim 1, wherein the face of each of the zodiac constellation cards comprise:
a) A unique numerical value
b) Zodiac constellation's name
c) Zodiac constellation's English name
d) Zodiac constellation's symbol
e) Dates corresponding with each zodiac constellation

6. A deck of playing cards as in claim 1, wherein the face of the wild cards comprise;
a. An identical numerical value
b. An image of one of the following; a black hole, a supernova, a comet, and a meteor.
c. The word Wild Card

7. A deck of playing cards as in claim 3, wherein the face of each of the alphabet cards comprise:
a. A Greek letter name
b. Greek uppercase letter
c. Greek lower case letter
d. Greek to Latin equivalent
e. Additional Latin variant(s)

8. A deck of playing cards as in claim 3, wherein the face of each of the alphabet cards comprise:
a. A Greek letter name
b. Greek uppercase letter
c. Greek lower case letter
d. Greek to Russian equivalent
e. Additional Russian variant(s)

9. A deck of playing cards as in claim 3, wherein the face of each of the alphabet cards comprise:
a. A Greek letter name
b. Greek uppercase letter
c. Greek lower case letter
d. Greek to Arabic equivalent
e. Additional Arabic variant(s)

10. A deck of playing cards as in claim 3, wherein the face of each of the alphabet cards comprise:
a. A Greek letter name
b. Greek uppercase letter
c. Greek lower case letter
d. Greek to Hebrew equivalent
e. Additional Hebrew variant(s)

11. A deck of playing cards as in claim 3, wherein the face of each of the alphabet cards comprise:
a. A Greek letter name
b. Greek uppercase letter
c. Greek lower case letter
d. Greek to Hindi equivalent
e. Additional Hindi variant(s)

12. A deck of playing cards as in claim 3, wherein the face of each of the alphabet cards comprise:
a. A Greek letter name
b. Greek uppercase letter
c. Greek lower case letter
d. Greek to Chinese equivalent
e. Additional Chinese variant(s)

13. A deck of playing cards as in claim 3, wherein the commonly known mathematic definitions are included on the alphabet cards.

14. A deck of playing cards as in claim 3, wherein the commonly known mathematic variables are included on the alphabet cards.

15. A deck of playing cards as in claim 3, wherein the commonly known mathematic constants are included on the alphabet cards.
